(19) United States
(12) Patent Application Publication
(10) Pub. No.: US 2008/0294472 A1
(43) Pub. Date: Nov. 27, 2008

(54) Server For a Distributed Power Generation Management System and Power Generation Management System Using the Same

(76) Inventor: Kazuo Yamada, Nara (JP)

Correspondence Address: NIXON & VANDERHYE, PC, 901 NORTH GLEBE ROAD, 11TH FLOOR, ARLINGTON, VA, 22203, US

(21) Appl. No.: 11/883,485

(22) PCT Filed: Jan. 25, 2006
(86) PCT No.: PCT/JP2006/301138

§ 371 Date: Apr. 28, 2008

(30) Foreign Application Priority Data
Feb. 2, 2005 (JP) 2005-026542

(51) Int. Cl. G06Q 10/00

(52) U.S. Cl. 705/7; 705/412

(57) ABSTRACT

This invention is a server for calculating a value of a power generated by distributed power generation with a small environmental load. The server has a function of receiving power information on a distributed power-generation facility transmitted through a network from an information terminal possessed by at least one of a holder of the distributed generation facility, a power manager of the distributed generation facility, and a trader brokering power related payment of the holder of the distributed generation facility, a function of accumulating the received power information, directly inputted power information, and value information used for determining a value of the power, and an arithmetic function of calculating the value of the power from the power information and value information.

In a distributed power generation management system, the value of the power generated by using natural energy is calculated and evaluated so as to expedite introduction of the generation facility using natural energy.

### TECHNICAL FIELD

The present invention relates to a server for a distributed power generation management system for managing a power generated by natural energy, and further specifically, relates to the server for the distributed power generation management system having a function capable of setting a value of the power generated by natural energy.

### BACKGROUND ART

Due to a growing consciousness on the environment in recent years, introduction of a generation facility using natural energy is promoted on a global basis. At present, introduction of these generation facilities has been promoted by fully or partially subsidized by a support measure by subsidy of each country.

In addition, in order to expedite the subsidy to natural energy and energy saving, there is a suggestion such as collecting an environmental tax directly or indirectly to return a tax revenue newly to an environmental contribution. Therefore, the introduction of natural energy with small environmental load will be expedited hereafter.

Meanwhile, in order to diffuse these generation facilities, by an effort such as increase of performance and reduction of cost by a company who develops, manufactures, and sells the generation facility, a price of the generation facility has been steadily reduced these years, and further by a power purchase menu at an economically profitable price and by a method such as improving economy as an overall system by using together the other energy saving equipment to assist the introduction of these generation facilities, a diffusion rate thereof has been steadily rising.

When power demand is paid more attention to, along with an improvement in convenience of various OA machineries, air conditioner facilities, and other household appliance articles, power consumption has been rising year by year, and further a load factor, which is a ratio of electric energy of a peak hour to an average power, has been deteriorated year by year. A deterioration of load factor involves a problem that a power company is required to maintain the generation facility for responding to peak power, and the generation facility cannot be effectively used. In addition, thermal power generation that can be easily started and stopped is mainly used as the generation facility for responding to load variation. Therefore, a discharge of CO₂ is large, compared to average all power, and this is not preferable from the viewpoint of an anti-environmental aspect. Therefore, various kinds of examinations and actions are tried to level a power load.

Further, the conventional regulation is relaxed step by step from now on by means of power liberalization, and purchase of power from not only a power company but also from an independent power generation trader is enabled. Therefore, due to change in the environmental consciousness and the regulation, it appears that there are various needs, while incapable of retaining the generation facility, such as enhancing a ratio of natural energy out of self-consumed energy, or assisting the introduction of natural energy in some way.

In addition, in a special case involving a power sale, such as a large-scale generation facility like a green power fund and a green power paper, there is partly a mechanism of circulating an added value related to an environmental value of natural energy.

Patent Document 1 suggests a photovoltaic power generation management server for collecting information on a power generation and a power consumption, etc., preparing useful advice information for a cost cut, and providing it for a user.

### Patent Document 1: Japanese Laid-Open Patent Publication No. 2003-259551

### DISCLOSURE OF THE INVENTION

### Problem to be Solved by the Invention

Although spread of natural energy is steadily progressed, a power generation cost including an introduction cost has not reached a level identical to levels of conventionally used generation facilities. The fact is that a balance thus generated is compensated by an assistance received from a country or a self-governing body, and a rate menu with an advantageous condition provided by the power company, or an individual burden having high environmental consciousness.

Particularly, the user who holds small generation facility such as family use cannot receive a benefit of an advantageous rate menu directly from the power related to a power value of a self-consuming power part and the power consumed by the facility with natural energy. Instead, normally a usual case is that the consciousness of an installer on environmental contribution and convenience of an establishment construction compensate therefore.

Meanwhile, the user has not only a demand of not only the environmental contribution, but also a demand to collect an investment needed for installation as early as possible. Accordingly, in order to aim at a full-scale spread, such a demand of the user needs to be satisfied.

In the country, although there is a problem of the aforementioned deterioration of the load factor, there is no system of grasping the situation of the value of power wherein the generation facility affects a reduction of the load factor, and it is impossible to actually classify the power. Therefore, a problem is that a flat rate must be set by the power purchase menu, or the like.

From the viewpoint of the user having the generation facility, this causes a drawback to occur such that a high valuable power cannot be purchased but at a flat rate. Meanwhile, from the viewpoint of a stance of purchasing such a power, a drawback occurs such that even the power of time and season, when the value as the power is low, must be purchased at a flat rate, specifically at a rate setting that ignores a difference of generation cost by other generation facility.

At present, a diffusion rate is low, and therefore the aforementioned problem is not surfaced. However, when full-scale diffusion occurs in future, a system to evaluate in accordance with a value of such power may be necessary.

However, there is no system to collect basic information for evaluating the value of the power, namely, there is no facility management system for managing a power quantity corresponding to the value of the power.

In view of the above-described circumstances, the present invention is provided, and an object of the present invention is to provide a server for a distributed power generation management system capable of appropriately evaluating a value of power generated by using natural energy and promoting introduction of a generation facility using natural energy.

### Means for Solving the Problem

The present invention provides a server for a distributed power generation management system for calculating a value of a power generated by a distributed power generation with a small environmental load.

The server comprises a function of receiving power information on a distributed power-generation facility transmitted through a network from an information terminal possessed by at least one of a holder of the distributed power-generation facility, a power manager of the distributed power-generation facility, and a trader brokering power related payment of the holder of the distributed power-generation facility, a function of accumulating the received power information, directly inputted power information, and value information used for determining the value of the power, and an arithmetic function of calculating the value of the power from the power information and the value information.

The present invention also provides the server for the distributed power generation management system characterized in that the power information accumulated in the server includes at least a total generated power quantity of the distributed power-generation facility and consumption distinction information.

Further, the present invention provides the server for the distributed power generation management system characterized in that a part of or an entire part of the power information on the power-generation facility is acquired through a home page.

Further, the present invention provides the server for the distributed power generation management system characterized in that the power information reversely flown to a system included in the power information on the power-generation facility is received by an information terminal possessed by either one of the power manager of the distributed generation facility and the trader brokering the power related payment of the holder of the distributed generation facility.

Further, the received power information includes information for specifying a kind of the power-generation facility.

Further, the present invention provides the server for the distributed power generation management system, the server further having a function of calculating a total generated power quantity of the power-generation facility by using previously registered information on a power-generation facility output of the power-generation facility and a change in output due to an environmental condition and aged deterioration. However, information used is not limited to the above three kinds of information.

Further, the value information includes value acquisition intender information and consideration information provided for a value acquisition intender to acquire the value.

Further, the present invention provides the server for the distributed power generation management system characterized in that the power-generation facility is a photovoltaic generation system, and a total generated power quantity of the generation facility is calculated by using information on power generating performance which is specific to the facility and is calculated by using a solar irradiation quantity actually measured at a installation site and a generated power quantity, and solar irradiation data of a installation area.

### EFFECT OF THE INVENTION

According to the present invention, a consideration is given to the power generated by using natural energy whose value is not conventionally clear. Therefore, a preferred profit is given to both of a subscriber who possesses a generation facility using natural energy and a trader (value acquisition intender) who acknowledges a value in such a self-generation and gives the consideration thereto, and thus introduction of the generation facility using natural energy can be promoted.

In addition, since the consideration is given to the subscriber by classifying the consideration with each piece of information, subscriber's consciousness of the energy saving and energy creation can be enhanced.

### BRIEF DESCRIPTION OF THE DRAWINGS

FIG. 1 is a block diagram showing an overall structure of an example of a generation facility management system of the present invention.

FIG. 2 is a flowchart of acquisition and generation processing of power information on a generation facility (photovoltaic power generator) of the present invention.

FIG. 3 is a flowchart of information processing in a management server of the present invention.

FIG. 4 is an explanatory view of an example of a label attached to the generation facility in the present invention.

FIG. 5 is a flowchart of selection processing on a consideration of the present invention.

FIG. 6 is a flowchart for receiving power data from a power company.

FIG. 7 is a flowchart for acquiring the power information utilizing a home page.

FIG. 8 is an explanatory view of an example of a display of the home page.

### BEST MODE FOR CARRYING OUT THE INVENTION

As a distributed power generation management system with the small environmental load according to the present invention, there are given examples such as a photovoltaic power generator, a wind power generator, microhydraulic power generator, a power generator using a fuel cell, a power generator using a gas engine, and a biomass power generator, and so forth, and a facility scale does not have a particular limit. However, in a case of a large-scale generation, transaction of its environmental value can be easily performed independently. Therefore, the present invention is particularly effective in a case of a coexistence of a small system for which buying and selling of its value independently is difficult. As the small system, the power-generation facility of 20 KW or less, and further 10 kW or less used in a general home is given as an example. Utilization thereof is particularly effective in a state where a plurality of generation facilities of different owners are connected by a network with a scale of more than several thousand thereof.

Also, the power-generation facility is installed in every building such as a house of a single-family, an apartment, and a building, or is installed as a street light on a public road. A management server, for example, for adding up power values of natural energy, is installed in a company who intermediates between a provider of the value and an acquisition intender of the value. Both of them are connected through a network such as Internet, a dedicated line, or a power line.

Further, power-generation facility information (kind, output, installation place, initial power generation capability, deterioration coefficient due to deterioration with age, and environmental load of the generation facility), power generation time zone information, consumption distinction information, and identification information on the power-generation facility (such as specific ID number) are given as examples of power information stored in the server of the present invention.

A power manager of a distributed power-generation facility in the present invention means a trader who supplies power to a holder of this facility and purchases power generated by the facility, and corresponding to a power company, an ESCO trader or a trader who performs meter-reading by being consigned from the power company.

An agency brokering the distributed power-generation facility holder's payment for power means an agency which brokers or intermediates a financial transaction generated by purchase and sale of the power, exemplified by financial institutions such as a bank, workers' credit union, and a post office.

Information such as a consumption form and time required for consuming the power, and identification information (such as specific ID number) of the power-generation facility are given as the distinction information on consumption.

It appears that the “consumption form” includes (1) consumption by using power generated by a power generating section, (2) consumption by power supply to a neighborhood facility, (3) consumption by reverse power flow to a grid, and (4) consumption by a facility connected to another generation facility owned by a third person. However, the consumption form is not limited thereto.

Here, the power generated by the power generating section means power generated by using natural energy, and consumption by using the power described in (1) means a consumption form (called self consumption) such as consuming the power with self-possessing electric appliances.

Both of the above descriptions (2) and (3) do not mean self consumption with self-possessing facilities, but can be targets to give the consideration in that they contributes to environmental safeguard by allowing others to use the power generated by natural energy. However, in the description (3), when the power including a contribution degree to the environment is sold to a power company, it is not the target to give the consideration.

The consumption form of the description (4) means the consumption in a case where, while not possessing a power-generation facility using natural energy by oneself, the one invests in the power-generation facility using natural energy owned by a third person, and when the third person consumes the power, power consumption by the third person is regarded as self-consumption. In other words, this consumption form means that a person who really owns the generation facility and consumes the power, and a person who contracts with the management system and receives the consideration are different.

The value of the power in the present invention means the value given to each power distinguished by power generation or the consumption form of the generated power in accordance with an extent of contribution to the environmental safeguard and load reduction to a power system. For example, when the power is consumed by the power-generation facility using natural energy, it appears that the consumption form includes the aforementioned various forms. However, when the consumption contributes to environmental improvement, or contributes to load reduction in the power system, the value is recognized, and the value can be specified if the extent of contribution is specified by managing the generated power information and consumed power information.

In addition, the consumption form is not limited to the above-described consumption forms, but various forms can be considered. Even when electrical power is consumed with facilities of a building of oneself, if discrimination can be made between the consumption by facilities required for a normal life (such as a refrigerator), and the consumption which is unnecessary for minimum life and the consumption by the facilities (such as an amusement and game) considered to be able to save consuming if a user endures, it can be considered that different considerations can be set between the above consumptions. Also, even when it is difficult to minutely set the considerations for the above consumptions, it is possible that the power consumption is set to several phases, and the consideration is set to each of them.

The third person who desires to acquire the value thus set can acquire the value by giving the consideration corresponding to the value. In the present invention, the consideration desired to be given by the third person for acquiring the value, is treated as consideration information.

The consideration information is composed of the consideration and a condition for obtaining the consideration. An article, money, a credit deposit ticket, and a contribution point, etc., given correspondingly to the power consumption quantity correspond to the consideration. The consideration information is given in the form of showing a condition of the consideration (called a value acquisition condition), and for example, the consideration information is data obtained by digitizing or encoding information such that when a condition of “A” is satisfied for the power consumption, an article (consideration) of “B” is given without charge. An explanation will be given in detail later.

As a factor for determining the consideration, information for specifying the power generation form is also used. As the information specifying the generation form, examples thereof includes information for distinguishing the kind of power generation using natural energy, and information for distinguishing a geographical condition of the generation facility and a time zone of generating the power.

For example, when the power which can be supplied to the third person is generated in a time zone with a large power demand, its consideration is set to be large.

In addition, as another factor, there is a possibility that the consideration fluctuates by an amount of value acquisition intenders. When there are more power value acquisition intenders with respect to a total power provided with a power value, the consideration becomes higher by necessity.

Further, in the power generation management system of the present invention, when the server may have a function of storing disclosure information in which the disclosure information including the consideration information is stored and there are a plurality of pieces of consideration information thus stored, all the pieces of the consideration information related to the power information may be selected, the disclosure information including all the pieces of the consideration information thus selected may be set in a viewable state, and when receiving information showing that a possessor of the power value selects particular consideration information out of the viewable disclosure information, the consideration included in the selected consideration information may be determined as the consideration of the power value.

Further, it is also possible that a difference in consideration is given, depending on a contract content between an owner (subscriber) of the generation facility, the provider of the management system, the value acquisition intender, or the power company. Therefore, the information on the contract content may be included in the power information.

For example, in a contact of a power sale, the information such as a contract period for power sale, a time zone of power sale, a maximum power for sale may be included in the power information. Also, in order to distinguish the consideration by the contract content such as presence of power supply to neighborhood facilities, a setting method of the value of power, and the kind of a representation supplier, the information on these contract contents may be included in the power information.

The power information transmitted to the server may be sent to the management server with the information for distinguishing the power consumption quantity and the consumption form generated in a constant period at the power-generation facility side, and the power consumption quantity may be accumulated by each consumption form in the management server. Alternatively, the power consumption quantity may be accumulated by each consumption form at the power-generation facility side, which may be then sent to the management server for each consumption form every time the power consumption quantity exceeds a predetermined quantity.

It is possible to use any transmission procedure (protocol) and any communication network between the power-generation facility and the management server, which are used at present, and they are not limited to particular ones. However, in sufficient consideration of interchangeability, secrecy, and speed of the communication, an appropriate one should be selected between the power-generation facility and the management server.

When the power information on the power-generation facility is sent to the server from a terminal possessed by the possessor of the power-generation facility, a home page provided correspondingly to the server may be opened, and while viewing a display screen of this home page, prescribed information may be inputted in accordance with a display message. Alternately, a bar code may put on a debit note sent from the power company, and by reading information embedded in this bar code by using a bar code reader attached to the terminal, the data may be acquired from the server.

In addition, a page for confirming a power charge in the home page of the power company may be opened, and a user may input necessary information and numerical values to transmit information on the power-generation facility to the server.

The present invention will be explained in detail based on the drawings. Incidentally, the present invention is not limited thereto.

### <Structure of Generation Facility Management System>

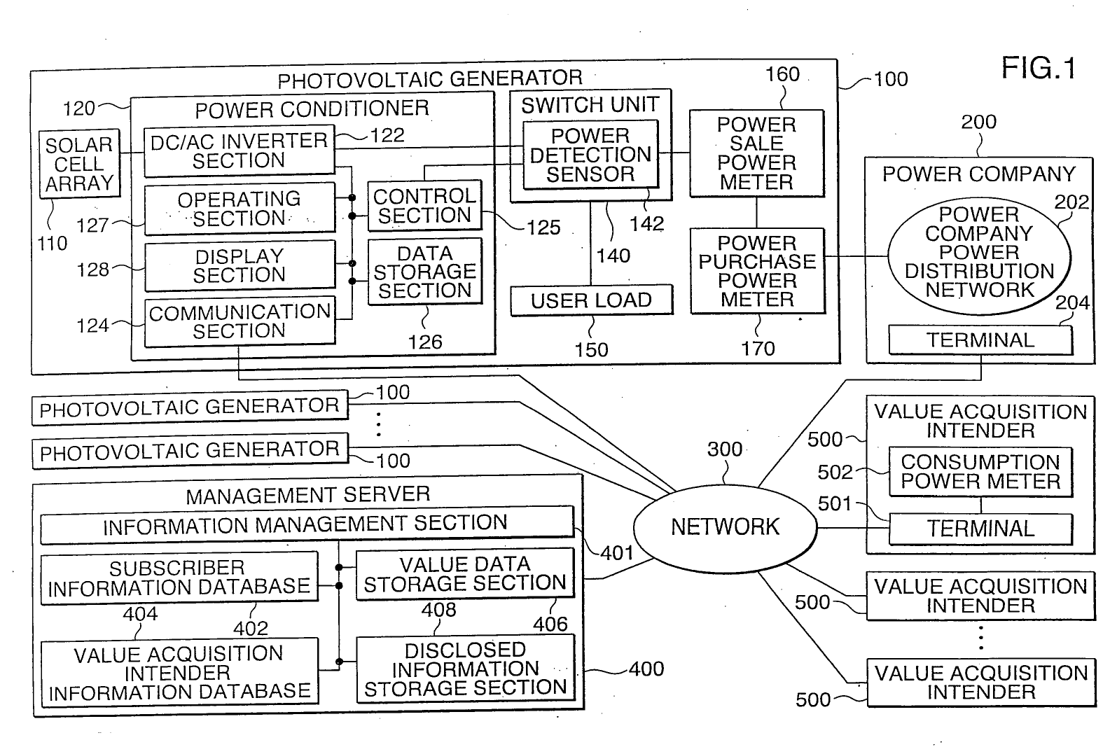

FIG. 1 shows an entire constitutional block diagram of an embodiment of the generation facility management system using natural energy of the present invention.

In the embodiment described hereunder, the generation facility management system using sunlight as natural energy is used, but the embodiment is not limited thereto.

The generation facility management system of the present invention is mainly constituted of a photovoltaic generator 100 and a management server 400, and includes a terminal 204 owned by a power company 200, a power company power distribution network 202, and a terminal 505 owned by a value acquisition intender 500.

The device 100, the server 400, the terminals (204, 504), and a network terminal for confirming a power generating state by a subscriber or the like are connected through a network 300 such as an Internet.

As the photovoltaic generator 100, a photovoltaic generation system installed at each user's house and every building such as an apartment, or installed for a purpose of generating power, and an illumination provided with a self-consumption type photovoltaic generator are given as examples.

The photovoltaic generator 100 is a device for generating power by receiving the sunlight and managing information on the power, and is mainly constituted of a solar cell array 110, a power conditioner 120, a switch unit 140, a user load 150, and two kinds of power meters (160 and 170).

Here, the solar cell array 110 is a generator for generating the power upon receiving the sunlight, wherein existing various kinds of panels can be used, and sunlight energy is acquired as a direct current.

The power conditioner 120 is the part for generating the power based on the direct current extracted from the solar cell array 110 and controlling and managing the information on the power quantity.

The switch unit 140 is the part for supplying the power generated in the solar cell array and a commercial power supplied from the power company to each user load 150.

The user load 150 means electric apparatuses used by a user (such as PC and television) and neighborhood facilities and attached facilities that consume the power obtained by the solar light generation.

The power meter is composed of a power sale power meter 160 for measuring the power for selling to the power company 200 (called a power sale power), and a power purchase power meter 170 for measuring the power for purchasing the power from the power company 200 conversely (called a power purchase power).

A case where the power conditioner 120 is connected to the network is described in FIG. 1. The power conditioner 120 is mainly constituted of a DC/AC inverter section 122 for converting the direct current extracted from the solar cell array 110 into an alternating current, a data storage section 126 for storing information related to the power, a communication section 124 for performing data communication by being connected to the network 300, an operating section 127 for being inputted data by a user, a display section 128 for displaying the data, and a control section 125 for controlling an operation of each constituent element.

Here, for example, the power generation quantity generated in the solar cell array 110, time required for generating the power, power consumption quantity consumed by the user load 150, time required for consuming the power, the consumption form, the power sale power quantity, and time required for selling the power, are stored in the data storage section 126. As shown in this figure, when the power conditioner is connected to the network, such stored information can be transmitted to the management server 400 through the network 300.

The switch unit 140 is connected to the DC/AC inverter section 122, the power sale power meter 160, and the user load 150, and the switch unit 140 has a function to detect the power consumption, and has a power detection sensor 142 for detecting the power (power consumption), etc., consumed by the user load 150.

The power detection sensor 142 detects separately each of the power consumed by the user load 150 out of the power (power generation) generated by the solar cell array 110, and the power quantity (power sale power quantity) which is sold through the power company's power distribution network 202 out of the generating power.

The switch unit 140 further has a function to communicate with a consumed household electrical appliance, and it is also possible to add a function to manage the power consumption for every consumption facility.

The power sale power meter 160 is connected to the power detection sensor 142 and the power purchase power meter 170, and measures the quantity of the power to be sold to the power company.

The power purchase power meter 170 is connected to the power sale power meter 160 and the power company power distribution network 202, and measures the power quantity of the power purchased from the power company.

A keyboard, a mouse, and a touch panel, etc., are used as the operating section 127, and a display device such as a CRT and an LCD is used as the display section 128.

The communication section 124 is a part of performing connection control and sending/receiving data with respect to the network 300, and is, for example, a part having the function of performing communication by TCP/IP to the Internet. Although not shown, the management server 400 and the terminals (204, 501) also have a similar communication function as that of the communication section 124.

The operating section 127 is not necessarily required to exist inside the power conditioner, but can be substituted by using a personal computer installed outside.

The power company 200 is connected to the network 300 in addition to the distribution network 202 for supplying a so-called commercial power to the user, and has the terminal 204 for performing data communication with the photovoltaic generator 100 and the management server 400 of the present invention.

The terminal 204 can receive information stored in the management server 400, and can give a control instruction to the photovoltaic generator 100. For example, when certain abnormal information on the photovoltaic generator 100 is obtained from the management server 400, a stop instruction of a generation function is transmitted to the control section 125 of the photovoltaic generator 100 whose terminal 204 generates the abnormality.

The management server 400 adds up power values of natural energy, for example, which is installed in the company who intermediates between the value provider and the value acquisition intender, and serves as a device to manage and provide the information on the photovoltaic generator 100 and the subscriber.

As shown in FIG. 1, the management server 400 is mainly constituted of information storage sections (402, 404, 406, 408) for storing each kind of information, and an information management section 401 for acquiring, processing, and providing such information.

The information storage section includes a subscriber information database 402 storing the information on the subscriber who installs the photovoltaic generator 100 (a name, an address, device ID number, generated power information, consumed power information, and personal hobby taste, etc.), a value acquisition intender information database 404 storing the information on an intender (value acquisition intender) who intends to acquire a power value generated by the generation facility using natural energy (a name, an address, a requesting item, an acquisition requesting power, an acquisition power unit, and the consideration that can be provided for acquired power, etc.), and a disclosed information storage section 408 storing disclosed information that can be read by the subscriber.

Here, the data of the value of power means, for example, the data such as information on the degree of environmental contribution, information on the contribution to carbon dioxide reduction, information on expense for the reduction of a generation cost, and the data of the value of power is the data used for converting (processing) the information on the power consumption and power generation transmitted from the photovoltaic generator of the subscriber into the information on the consideration.

The disclosed information means, for example, generated power information and power value data of the subscriber, and acquisition consideration information on the value acquisition intender, and the disclosed information is the information disclosed to a user of the system of this invention.

The information management section 401 of the management server 400 receives/transmits each kind of information to the photovoltaic generator 100, then performs processing such as classifying, evaluating, and determining the value of the power using the power information thus obtained, and generating and storing the consideration information and generating and storing the disclosed information.

The subscriber information stored in the management server 400 is previously stored in the database 402, by using an input device not shown or by downloading from the photovoltaic generator 100 by communication, before the subscriber uses the management system. The value acquisition intender information is similarly previously stored in the database 404 before a use of the system starts.

The value acquisition intender 500 means the provider (such as a company, business connection, power trader, etc.) who founds the value in generated power and applies the consideration for the value of the power. The value acquisition intender 500 has a terminal 501 and a consumption power meter 502 for connecting to the management server 400 through a network 300. Here, the terminal 501 functions to give the requested information on itself to the management server 400, and obtains the disclosed information from the management server 400. Also, the consumption power meter 502 functions to measure the power quantity actually used by the value acquisition intender, and for example, is used for offsetting the power of the value provider and the power of the value acquisition intender.

The management server 400 and the terminals (204, 501) are also constituted of a personal computer and a work station, and its information processing function is realized by operating a microcomputer based on a control program incorporated in a ROM, etc.

### <Processing by Power-Generation Facility Management System>

First, an explanation will be given to acquisition and generation processing of the power information on the photovoltaic generator 100.

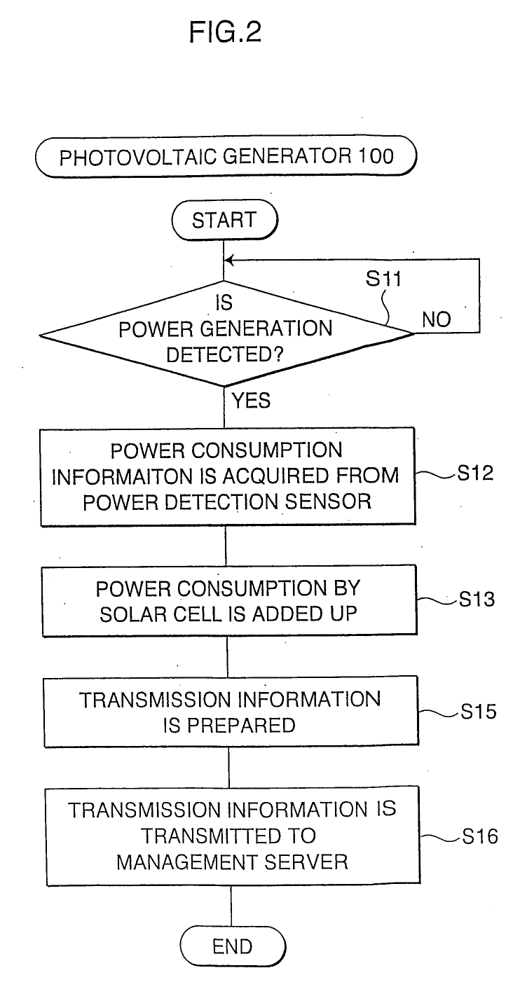

FIG. 2 shows a flowchart of the processing of the photovoltaic generator 100 of the present invention.

When the power is generated in the photovoltaic array 110, the power is transmitted to a DC/AC inverter section 122 as a direct current, and therefore the control section 125 detects a current change thus occurred. By existence/nonexistence of such a current detection, whether or not there is a non-commercial power generation by sunlight is confirmed. In step S11 of FIG. 2, the control section 125 confirms whether or not there is a power generation by sunlight.

When the control section 125 confirms the power generation, the information on the power consumption is acquired from the power detection sensor 142 (step S12).

The information on the power consumption out of the power provided by the photovoltaic power generation as described above can be obtained.

Next, in step S13, when the information on the power consumption is acquired, the control section 125 stores it in the data storage section 126. Here, when it is so assumed that the power quantity is added up per every one day and transmitted to the management server 400, a first power consumption is added for every generation of the power consumption, and the power quantity of one day is added up. However, a transmission unit is not limited to per every one day, but may be per every one week or per every one month.

In step S15, the control section 125 prepares transmission information by using the information on the power consumption thus added up. The transmission information is constituted of identification information on the subscriber who possesses the photovoltaic generator 100, power generation, power consumption, time required for consuming, consumption form, power sale power quantity, and the time required for selling power.

In step S16, the communication section 124 transmits the transmission information thus prepared to the management server 400 through the network 300. This transmission information corresponds to the aforementioned power information.

### <Information Processing in Management Server>

Next, the information processing in the management server 400 will be explained.

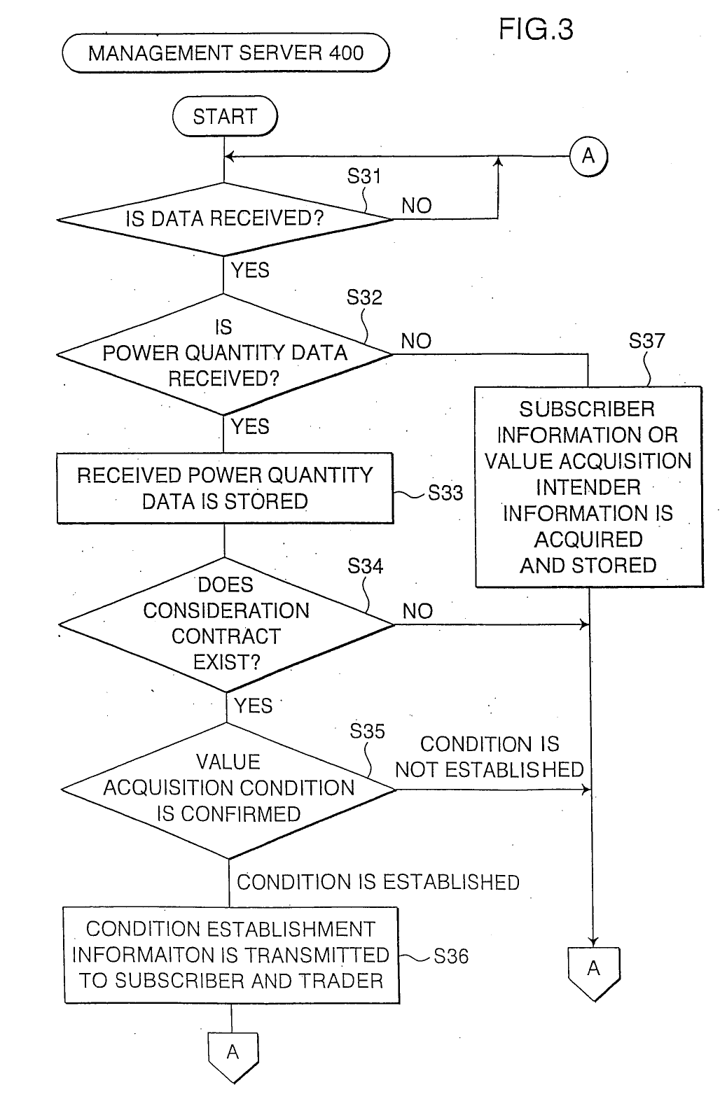

FIG. 3 shows a schematic flowchart of an embodiment of the information processing by the management server 400 of the present invention. This information processing is performed by the information management section 401.

First, in step S31, whether or not there is reception data is confirmed, and when the data is received from the terminal 501 of the photovoltaic generator 100 or the value acquisition intender 500, the processing is advanced to step S32. In step S32, content of the data thus received is confirmed, and whether or not it is power quantity data is determined. When it is the power quantity data, the processing is advanced to step S33, and when it is the other data, the processing is advanced to step S37.

In step S33, the information management section 401 analyzes the power quantity data thus received, and stores it in a prescribed storage section or database. For example, when the transmission information including the power quantity data is transmitted from the photovoltaic generator 100 by the processing of FIG. 2, the subscriber number included in the transmission information is confirmed, and the information on the power consumption thus received is stored in a storage region related to the subscriber in the subscriber information database.

Meanwhile, when the data thus received is not the power quantity data, in step S37, it is acquired and stored as the subscriber information or value acquisition intender information. For example, when the information for specifying the subscriber oneself and contract information on value acquisition of the subscriber are received, the information thus received is stored in the storage region of the information on the subscriber in the subscriber information database 402.

In addition, when the information specifying the value acquisition intender oneself, consideration information given by the intender, and advertisement information or the like is received, the information thus received is stored in the storage region of the information on the intender, of the value acquisition intender information database 404.

In step S37, after the information is acquired and stored, the processing is returned to step S31, to become in a stand-by state of data reception.

In step S33, after the power quantity data is stored, the processing is advanced to step S34, and the subscriber of the power quantity data confirms whether or not a consideration contract is effective. When the contract is effective, the processing is advanced to step S35, and when it is not effective, the processing is returned to step S31. Here, the consideration contract means the contract of value acquisition corresponding to the power quantity, concluded between a subscriber A and a trader B who is a power value acquisition intender.

The information on the consideration contract is previously stored in the subscriber information database 402 by the processing of step S37. For example, in step S34, if there is the information showing that the contract between the subscriber A of the received power quantity data and the trader B is effective, the processing is advanced to step S35.

In step S35, the content of the consideration contract is checked, to confirm whether or not a current state of the subscriber satisfies a value acquisition condition. Here, by using the information stored in two databases 402 and 404 and in the value data storage section 406, the power quantity data thus received is processed, to determine whether or not the content (condition) of the consideration contract is satisfied.

When the value acquisition condition is established, the processing is advanced to step S36, and based on the content of the consideration contract, condition establishment information showing establishment of condition is transmitted to both of the subscriber A and the trader B who make consideration contract. When the value acquisition condition is not established, the processing is returned to step S31.

Confirmation of the value acquisition condition in step S35 will be specifically explained.

For example, the following information on the subscriber A is assumed to be stored in the subscriber information database 402.

(A-1) Personal information on the subscriber A: Name, address, ID number, and telephone number
(A-2) Consideration contract information: Name of contract trader B, ID number of the trader
(A-3) Self power generation of the current self-consumption: 980 kWh

Also, the following information on the name of the contract trader B is assumed to be stored in the value acquisition intender information database 404.

(B-1): Personal information on the name of the trader B: Name, address, and ID number.
(B-2): Acquisition request total power quantity=30000 kWh
(B-3): Consideration information:

(1) Target article=A tableware set for camping

(2) Power quantity 1000 kWh required for exchange 30 subscribers of first arrival

(3) The subscriber admits to offset the self power consumption out of the self power generation and the power used in manufacturing a product by the trader B, and to use the result in a sales promotion activity.

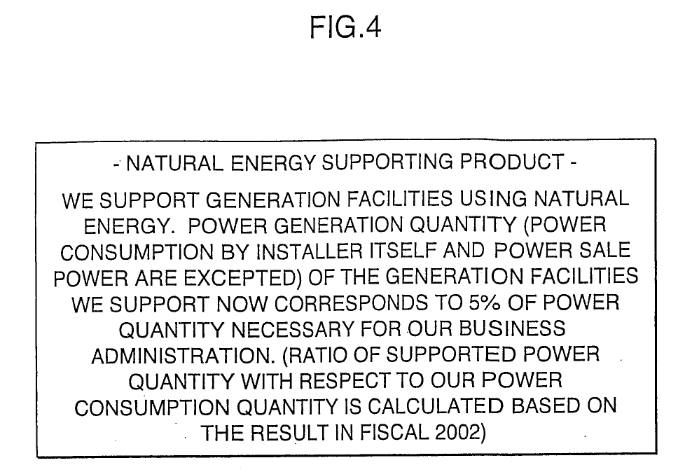

Here, the trader B sticks a label as shown in FIG. 4, for example, to the one's own company's product for the sales promotion of one's own company's product, and sells the product thus stuck with label. Meanwhile, the trader B promises to provide the product of the trader B (such as tableware set for camping) to the subscriber.

Here, as a specific example, the content of the consideration contract between the subscriber A and the trader B is assumed to be “when the self power generation of self-consumption reaches 1000 kWh in total, tableware set for camping is provided”.

In such a circumstance, in step S35, the current self power generation quantity of self-consumption of the subscriber A and (1000 kWh) which is a value acquisition condition of the consideration contract content of the trader B are compared.

In the aforementioned condition setting (A-3), the current self power generation (980 kWh) of the subscriber does not reach a total power quantity yet, and therefore the processing is returned to step S31 as it is.

Meanwhile, when the power consumption of the subscriber A is accumulated and the current power consumption reaches 1000 kWh, this means that the value acquisition condition (1000 kWh) previously set is exceeded. Therefore, by a comparison processing of step S35, the condition of the consideration contract is determined to be established.

In this case, the processing is advanced to step S36, and a message that the condition is established is reported to both of the subscriber A and the trader B.

Thereafter, the trader B who confirms the report of this condition establishment delivers promised tableware set for camping to the subscriber A.

By performing a series of processing as described above, various profits can be given to those involved in the photovoltaic generation facility management system. For example, the user (corresponding to the subscriber A) who installs the photovoltaic generator 100 has not received the evaluation of the value regarding the power of self-consumption heretofore, even if he/she contributes to environmental improvement by generating the power by using the photovoltaic generation facility. However, by this system, the consideration (tableware set for camping) can be obtained.

In addition, when further more users introduce the facility because of obtaining the consideration, those who provide the photovoltaic generation facility can obtain an economic profit. Further, not only those who provide the photovoltaic power generation, but also a general trader (corresponding to the trader B) can publicize one's own company's product as actions such as environmental improvement by performing convincing advertising (corresponding to sticking of the label), to the user who is expected to purchase one's own company's product, instead of giving the consideration to the subscriber.

Note that in the above-described explanation, the determination of the value is performed in the server, but the determination of the value is not limited to the server, but can be performed by a system on the side of the generation facility and an individual terminal for reading the information, after seeing the data of the server.

In other words, the power consumption by the photovoltaic generation produces a new value, and an owner of the generation facility can obtain the consideration by having the value accepted, and the trader who purchases (acquires) the value can get the profit that the one's own company's product can be easily and efficiently publicized to the person who plans to purchase the product, instead of giving the consideration to the owner.

Note that the above-described specific example shows an example that the self power generation quantity of self-consumption and the trader obtains the consideration by offsetting the power of self-consumption and the power used in manufacturing the product by the trader B, out of the self power generation, under a condition of using it for appealing the environmental contribution. However, various values can be considered as a target of the value.

As an added value when the self power generation is consumed, for example the following case is considered.

(1) The value to the degree of the environmental improvement by performing power generation using natural energy.
(2) The value to the degree of contributing to discharge reduction of carbon dioxide (CO₂) or the like.
(3) The value to contribution to the reduction of the generation cost of a commercial power (such as operating expense and installment expense), by selling the power to the power company and contribution to load leveling.

Such values are digitized and previously stored in the data storage section 406.

The aforementioned value can be calculated by using the self power consumption out of the self power generation, and for example, a point system is adopted, like setting 1 kWh as 1 point, and thus a financial value can be applied to the point. Further, the information on a time zone in which the power is generated and consumed is added, and the point can be minutely set based on the generated power information and the consumed power information, like setting 1 kW as 2 points for the power generated and consumed in a daytime of summer (a constant time range of a fixed period of time). In this way, when the point system is adopted, conversion of the power quantity to the point may be uniformly performed, or may be arbitrarily set by the value acquisition intender based on the profit of the value acquisition intender.

The trader B (value acquisition intender) may set an article, money, and a gold note, etc., to be given to the subscriber as a consideration, by the number of the points, for example.

Also, when such a value evaluation reference (1) is used, in step S35, in order to confirm the condition, by not using the power consumption but referring to the power information on the target power quantity, the process of converting (processing) the power consumption into data is performed, and thus the point is calculated and the point thus obtained and the previously set value acquisition condition may be compared.

In this way, digitized data stored in the value data storage section 406 is used for converting the power consumption into the aforementioned value data.

In addition, an element whereby the value is determined and the information such as an importance of the element may be stored in the value data storage section 406. In the aforementioned example, the time of generation and consumption is shown, but the kind of the generation facility and the consumption form are given as examples of other “element”.

The “importance of an element” means a weighting of the evaluation, and a high importance is applied to the power generated in the daytime at the height of summer, and a low importance is applied to the power generation of the time zone with a little demand.

For example, the kind of the generation facility includes the photovoltaic power generation, wind power generation, a fuel cell using biomass, and microhydraulic power generation, or the like. The consumption form includes a generation time zone, an object of the power consumption, consumption time zone, and existence/non-existence of power supply to neighborhood facilities, or the like. These elements and importance are digitized and stored.

The received power information is added with the importance by the digitized element and importance information, and is converted into data which is compared in step S35.

If the aforementioned element and importance information are used, the magnitude of the value of the power consumption can be set, in consideration of factors such as not only the magnitude of the received power consumption but also the quality of the power consumption, consumption time zone, and a facility scale.

Accordingly, since the power consumption is converted into previously set value data, various kinds of considerations and profits can be given to the user and a related trader using the generation facility, and the introduction of the generation facility using natural energy can be expedited.

### <Selection and Processing of Consideration>

Next, an explanation will be given to a specific example of an embodiment wherein the subscriber selects any one of the considerations out of a plurality of considerations. Here, the following information is assumed to be previously stored in the information storage section of the management server 400.

### Information Stored in Value Acquisition Intender Information Database 404

(1) Provider: The Trader B who manufactures and sells camping equipment.

Condition: Support situation should be printed in a home page of environmental contribution.

Consideration: Free tableware set for camping is provided to self power consumption of 1000 kWh out of the self power generation.

Acquisition request power quantity: 30000 kWh (The first 30 people).

(2) Provider: Trader C who sells flower arrangement by home delivery.

Condition: Support situation should be printed in a home page of environmental contribution.

Consideration: When the self power consumption out of the self power generation is 1500 kWh, a seasonal flower should be delivered to the subscriber.

Acquisition request power quantity: 30000 kWh (the first 30 people)

(3) Provider: Trader D who runs a resort hotel.

Condition: Support situation should be printed in a home page of environmental contribution.

Consideration: When the self power consumption out of the self power generation is 1000 kWh, lodging discount coupon of a resort hotel run by the trader oneself should be provided.

Acquisition request power quantity: 30000 kWh (The first 30 people).

### Disclosed Information Stored in Disclosed Information Storage Section 408

(4) Consideration of the trader B (Tableware set for camping)
(5) Consideration of the trader C (Delivery of a seasonal flower)
(6) Consideration of the trader D (lodging discount coupon of the resort hotel)
(7) Current exchangeable accumulated power quantity of the subscriber A.

Here, the disclosed information stored in the disclosed information storage section 408 is in a condition capable of being read if the management server 400 is accessed by at least the subscriber and the value acquisition intender.

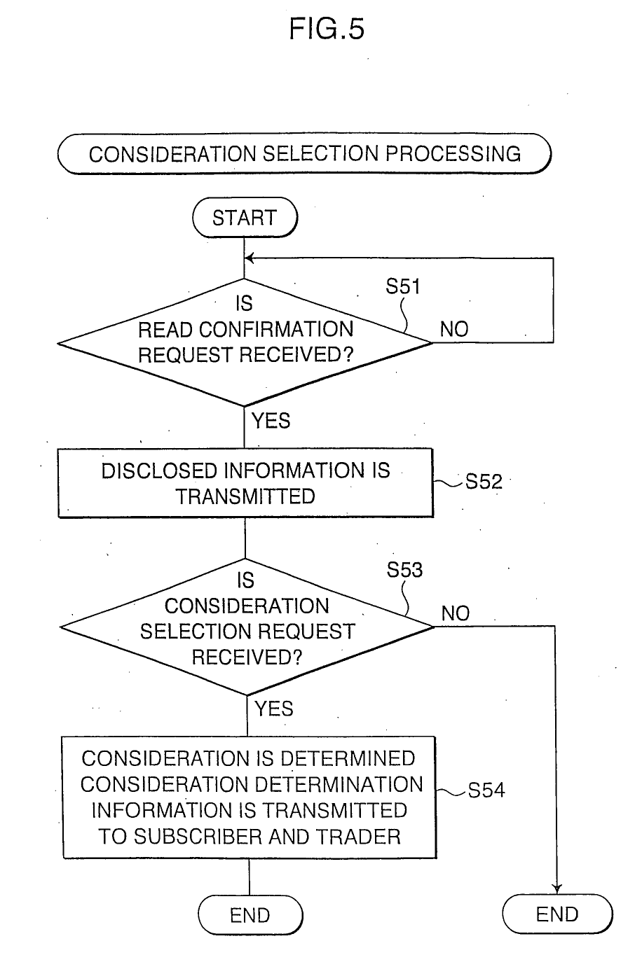

FIG. 5 shows a flowchart of a selection processing of the consideration of the present invention.

Under the above-described circumstances, the subscriber A connects the photovoltaic generator 100 or the terminal of oneself to the management server 400, and performs a read confirmation request operation of the disclosed information. When the management server 400 receives the read confirmation request (step S51), the disclosed information on the subscriber A is transmitted to the subscriber A (step S52). The disclosed information thus transmitted is displayed on the terminal, etc., of the subscriber A. By this disclosed information, the subscriber A can confirm current first self power consumption. At this time, the power quantity that can be exchanged with the consideration stored in the disclosed information section 408 is assumed to be 1600 kWh.

In addition, the subscriber A, who confirms that the power quantity that can be exchanged with the current consideration is 1600 kWh, searches or confirms whether or not there is the consideration that can be acquired with this power consumption. When there are assumed to be three considerations as described in the aforementioned (4) to (6) that can be acquired with the power consumption of the subscriber A in the transmitted disclosed information, the subscriber A confirms that there is the consideration information provided by these three traders (B, C, D).

When there is a requested consideration out of these three pieces of consideration information, the subscriber A selects this consideration.

For example, the subscriber A performs an operation of selecting the lodging coupon of the trader D. By this operation, the selected information (consideration selection request) is transmitted to the management server 400. When the information management section 401 of the management server 400 receives this request (step S53), the exchange of the power consumption and the consideration between the subscriber A and the trader D is determined to be established, and consideration determination information, showing a message that a consideration exchange contract is established, is transmitted to the subscriber A and the trader D (step S54).

Then, the trader D, who confirms that the consideration exchange contract is established to the subscriber A, sends the lodging coupon of the resort hotel to the subscriber A.

As described above, when there are a plurality of exchangeable considerations to the power consumption of the subscriber A, all pieces of the consideration information are disclosed to the subscriber A. Therefore, the subscriber A can select a requested consideration.

<<Specific Example of Receiving Power Data from Power Company>>

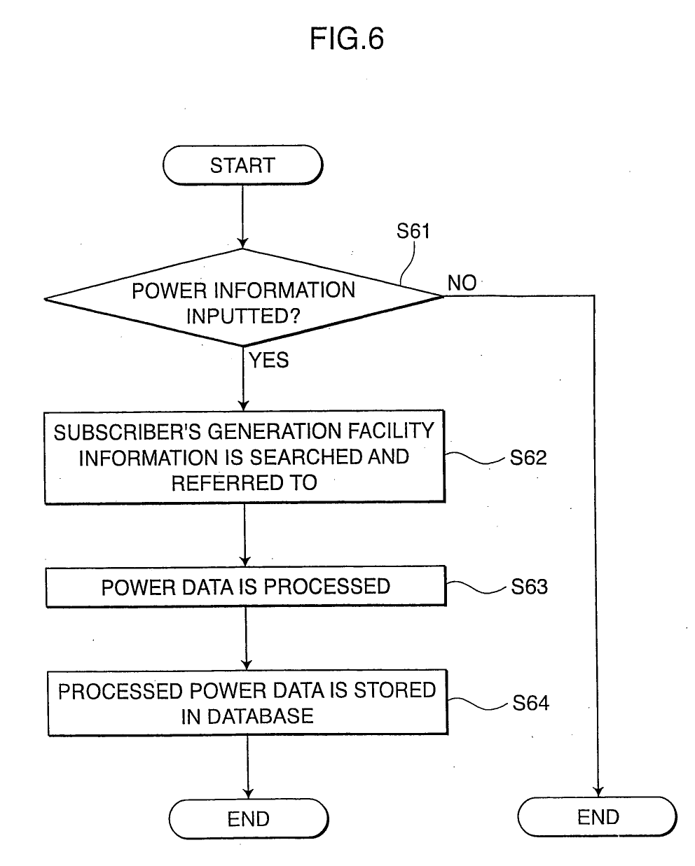

With reference to FIG. 6, explanation will be given to a case where the management server receives a part of the generated power information from the terminal of the power company. FIG. 6 shows a flowchart of the case where the server receives the power data from the power company.

Here, acceptance by the subscriber is previously obtained regarding that the data of the used power quantity and the power sale power quantity are directly provided from the power company, and, when a previously set period is elapsed, it is set so that the power information is automatically transmitted to the server from the terminal of the power company.

First, when the information on the power sale power quantity for one month and the ID number of the subscriber are transmitted from the power company as the power information, the server confirms whether or not the information is the power information (step S61).

When the server can confirm that the information is the power information, the server refers to the power-generation facility information such as the kind of the facility of the subscriber of which the data is sent and performance coefficients of the registered power-generation facility, by using the ID number of the subscriber (step S62).

Next, processing of the power data is performed. For example, a total generated power quantity of the power-generation facility is calculated from the performance coefficients of the power-generation facility and solar irradiation data, and a self-consumed power quantity of the subscriber owing the power-generation facility out of the power generated by the power-generation facility is further calculated by using the power sale power quantity received from the power company (step S63).

Finally, the acquired data and the calculated data are stored in a database (step S64).

Based on the stored data, the same utilization method as described above is performed, such as using the service of utilizing the value obtained according to the power generated and used by the power-generation facility. Thus, it is possible to exchange the value with the product provided by the value acquisition intender.

In this specific example, explanation is given to a case of utilizing the data of the power company. Usually, the power company uses a system of multiplying the used power quantity and the power sale power quantity (power purchase power quantity viewed from the power company) by a unit price and collecting the power charge through a financial institution. Therefore, it is also possible to acquire the power information from the financial institution by using the information for the financial institution to debit the power charge from the subscriber.

### <<Specific Example of Acquisition of Power Information Using Home Page>>

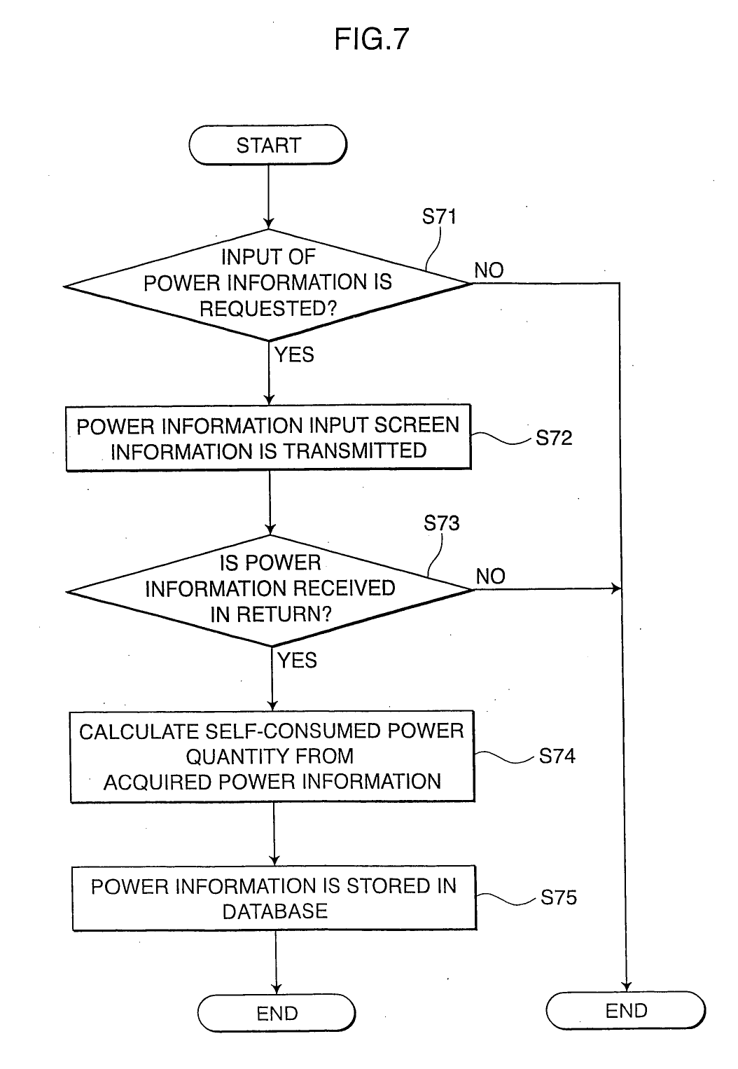

With reference to FIG. 7, explanation will be given to a case where the management server acquires a part of the generated power information on the subscriber through the home page. FIG. 7 shows a flowchart of the case of acquiring the power information using the home page.

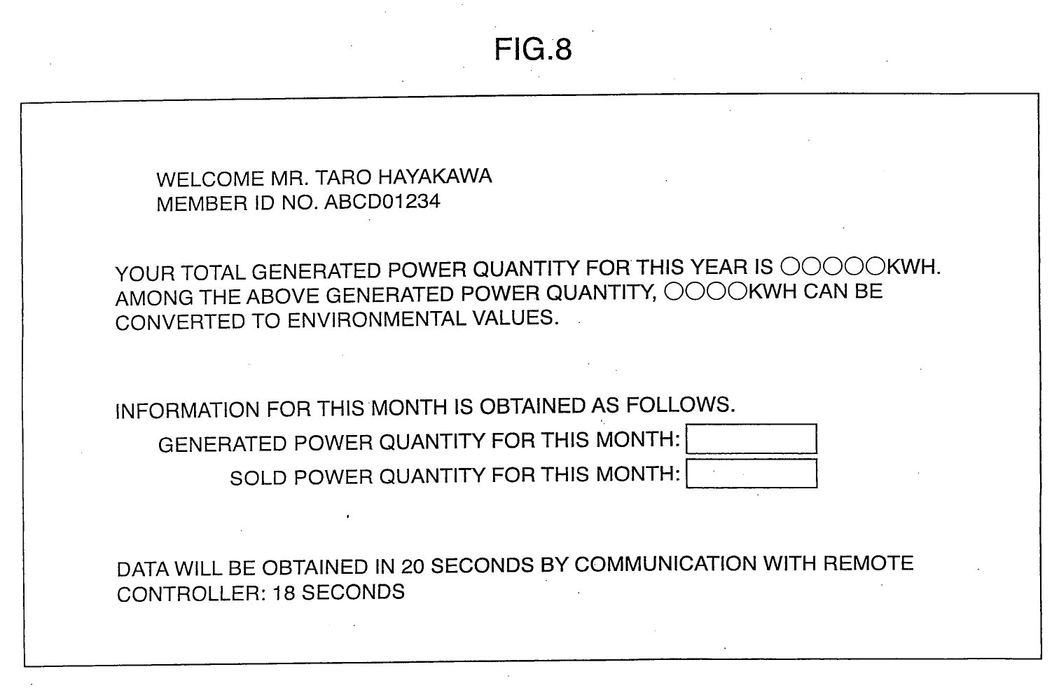

When the server receives an input request of the power information (step S71), the server transmits a power information input screen to the terminal of the subscriber (step S72 in FIG. 8). When the user confirms the input screen of the power information, wireless communication is made between the confirmed terminal and a remote controller displaying the generated power quantity, etc., of the photovoltaic generation system, and the generation facility ID, the total generated power quantity, and the power sale power quantity are acquired by the remote controller, and the power information is transmitted to the server.

When the server confirms a reply of the power information (step S73), the self-consumed power quantity by the possessor of the generation facility is calculated from the total generated power quantity and the power sale power quantity (step S74), and the power quantity thus calculated is stored in the database together with the received data (step S75).

Based on the stored data, the same utilization method as described above is performed, such as using the service of utilizing the value obtained according to the power generated and used by the generation facility. Then, it is possible to exchange the value with the product provided by the value acquisition intender.

In the above-described specific examples, explanation is given separately to a case of calculating the total generated power quantity by using the power generation information and the method of acquiring the total generated power quantity from the home page. Alternatively, by combining them, the data acquired from the home page and the total generated power quantity calculated by using the power-generation facility information may be compared to inspect accuracy of the power information, and when the accuracy is not confirmed, an operation such as requesting acquisition of data again may be performed so as to improve the accuracy of the data.

In addition, in the aforementioned examples, the power information is acquired by the communication with the remote controller attached to the personal computer. Alternatively, other methods are also possible, such as acquiring the data from input devices (barcode reader and keyboard) attached to the terminal, transferring the data from a received mail, and transferring the data by operating a button in the screen for confirming individual information.

In the above-described examples, explanation is given to the photovoltaic generator as the one example of the power-generation facility using natural energy. Alternatively, the system of the present invention can be applied to a case of using other power-generation facilities such as a wind power generator, a biomass generator, and a micro hydraulic power generator.

In addition, the value of the consumed power by the self-power generation using natural energy is fluctuated according to a balance of supply and demand. For example, as for the generated power in the afternoon of the summer when a peak of power demand occurs, it is considered that the value is higher than that of the other season.

Further, it is preferable to highly evaluate the power sold in the afternoon of summer. Alternately, it is considerable that the power company makes various kinds of rate plans to discount the power usage rate, in accordance with the power quantity sold in this season.

In addition, due to an entry of a new power trader, there is a possibility that a difference is made in the consideration set to the power of the same season and time zone among a plurality of traders.

In such a case, it is preferable to update the information stored in the value data storage section 406 each time so as to flexibly correspond to fluctuation and difference of the power value, without fixedly setting the power value beforehand.

In this way, when the power value is fluctuated in accordance with various circumstances, the subscriber's consciousness of energy saving and energy creation can be further raised, and mutual profits of the subscriber and the trader can be made more appropriate, and further the introduction of the power-generation facility using natural energy can be expedited.

Moreover, from the viewpoint of spread of the power-generation facility using natural energy, it is necessary for many users to set the power-generation facilities themselves. However, at present, a large amount of fund is necessary for the facility introduction. Therefore, although indirectly, the spread of the generation facility using natural energy can be realized by forming the management system of injecting the fund for the facility introduction by a third person and giving the consideration to such injection fund, or the management system of converting the number of times of participation in an energy-saving related event or the number of times of use and a used amount of money of a building in which the self-generated facility is installed into the power quantity or points determined by the power quantity to give the points at a time of value acquisition.

1. A server for a distributed power generation management system for calculating a value of a power generated by a distributed power generation with a small environmental load, the server comprising:
a function of receiving power information on a distributed power-generation facility transmitted through a network from an information terminal possessed by at least one of a holder of the distributed power-generation facility, a power manager of the distributed power-generation facility, and a trader brokering power related payment of the holder of the distributed power-generation facility;
a function of accumulating said received power information, directly inputted power information, and value information used for determining the value of the power; and
an arithmetic function of calculating the value of the power from said power information and said value information.

2. The server for the distributed power generation management system according to claim 1, wherein the power information accumulated in the server includes at least a total generated power quantity of the distributed power-generation facility and consumption distinction information.

3. The server for the distributed power generation management system according to claim 1, wherein a part of or an entire part of the power information on said power-generation facility is acquired through a home page.

4. The server for the distributed power generation management system according to claim 1, wherein the power information reversely flown to a system included in the power information on said power-generation facility is received by an information terminal possessed by either one of the power manager of the distributed generation facility and the trader brokering the power related payment of the holder of the distributed generation facility.

5. The server for the distributed power generation management system according to claim 1, wherein said received power information includes information for specifying a kind of the power-generation facility.

6. The server for the distributed power generation management system according to claim 1, the server further having a function of calculating a total generated power quantity of said power-generation facility by using previously registered information on a power-generation facility output of said power-generation facility and a change in output due to an environmental condition and aged deterioration.

7. The server for the distributed power generation management system according to claim 1, wherein said value information includes value acquisition intender information and consideration information provided for a value acquisition intender to acquire the value.

8. The server for the distributed power generation management system according to claim 1, wherein said power-generation facility is a photovoltaic generation system, and a total generated power quantity of the generation facility is calculated by using information on power generating performance which is specific to the facility and is calculated by using a solar irradiation quantity actually measured at a installation site and a generated power quantity, and solar irradiation data of a installation area.

9. A power generation management system, wherein the server according to claim 1, is used.
